(19) United States
(12) Patent Application Publication
(10) Pub. No.: US 2026/0044741 A1
(43) Pub. Date: Feb. 12, 2026

(54) COLLABORATIVE DATA ACQUISITION FOR MACHINE LEARNING TASKS USING NATURAL LANGUAGE ARTIFACTS

(71) Applicant: Google LLC, Mountain View, CA (US)

(72) Inventors: Sian Gooding, London (GB); Lukas Zilka, Zurich (CH); Matthew Sharifi, Kilchberg (CH); Blaise Aguera-Arcas, Seattle, WA (US); Amirkeivan Mohtashami, London (GB); Florian Nils Hartmann, Zurich (CH)

(21) Appl. No.: 18/798,604

(22) Filed: Aug. 8, 2024

(51) Int. Cl. G06N 3/096; G06N 3/045

(52) U.S. Cl. CPC G06N 3/096; G06N 3/045

(57) ABSTRACT

Methods, systems, and apparatus, including computer programs encoded on computer storage media, for updating a student neural network in a privacy aware (compliant with private data sharing restrictions) manner using additional data generated from other neural networks to improve the quality of machine learning task outputs. In particular, a system receives a request to generate additional data for a machine learning task, uses teacher computer systems to generate natural language teacher artifacts, updates a student neural network using the generated teacher artifacts, and processes inputs for the machine learning task to generate improved quality outputs for the machine learning task.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers that updates a student neural network using additional data generated from other neural networks to improve the quality of machine learning task outputs generated by the student neural network.

That is, the system processes a request to generate additional data for a machine learning task by using teacher computer systems to generate natural language teacher artifacts and then updating the student neural network using the generated artifacts. After the student neural network has been updated, the system can then process inputs for the machine learning task using the student neural network to generate improved quality outputs for the machine learning task.

The subject matter described in this specification can be implemented in particular embodiments so as to realize one or more of the following advantages.

Neural networks are incredibly useful for performing many real-world tasks including answering questions about a large text corpus, analyzing sentiments of text, summarizing text and so on.

Often, new unique data, if used to update a neural network, will improve the quality of the outputs of the neural network. For example, new task-specific data can be used to update a general-purpose neural network, e.g., a large language model (LLM), to improve the performance of the neural network on a specific task.

For example, when a given system receives a request to perform a new task using a neural network maintained by the system, other systems, e.g., other user devices or other systems that store data associated with other devices, may have access to relevant data that can greatly improve the performance of the neural network on the new task.

But in practice, transferring data among different systems may not be feasible.

For example, the data associated and available to any given system may be subject to restrictions on sharing private data. That is, the data may be private and cannot be shared to preserve the privacy and security of the data.

As another example, the computational expense associated with sharing data across a network can be significant and therefore data cannot be sent between systems without excessive data communication costs.

As another example, the data associated with a given system may be formatted for use with a given neural network that has a different neural network architecture.

Thus, transferring data among neural networks needs to be privacy aware (compliant with private data sharing restrictions), computationally efficient, and agnostic to the underlying neural network architectures. Existing methods generally cannot satisfy these requirements.

For example, directly sharing data may be agnostic to the architectures of the various neural networks but may not be privacy aware and is potentially computationally expensive to execute. While only sharing data marked as non-private may alleviate the lack of privacy awareness there could still be a prohibitive computational cost with directly sharing data. Moreover, sufficient non-private data may not be available for many tasks.

As another example, federated learning trains neural networks with data local to the neural network and exchanges parameters (e.g., the weights and biases of a neural network) with other neural networks. This technique may be privacy aware, but sharing parameters of a large neural network can be more computationally expensive than directly sharing data. Additionally, this technique necessitates that all neural networks have the same architecture.

This specification on the other hand, describes a collaborative data acquisition system that is simultaneously privacy aware, computationally efficient, and agnostic of any neural network architecture present. By generating non-private natural language teacher artifacts based on private data through a teacher computer system, a student neural network system can be updated in a privacy aware manner, computationally efficiently, regardless of any neural network architectures present.

The details of one or more embodiments of the subject matter of this specification are set forth in the accompanying drawings and the description below.

Other features, aspects, and advantages of the subject matter will become apparent from the description, the drawings, and the claims.

### DESCRIPTION OF DRAWINGS

FIG. 1 shows an example collaborative data acquisition system.

FIG. 2 is a flow diagram of an example process for generating additional data for a machine learning task and using the data to update a student neural network.

FIG. 3 shows an example of the one or more teacher computer systems.

FIG. 4. shows an example of the teacher computer system.

### DETAILED DESCRIPTION

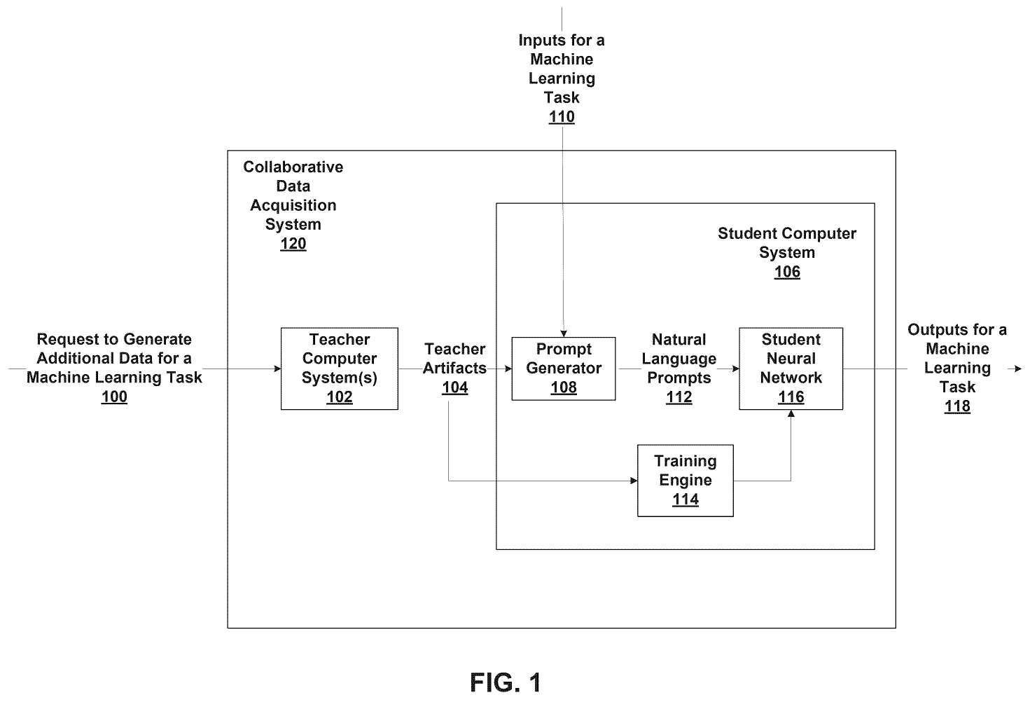

FIG. 1 shows an example collaborative data acquisition system 120. The collaborative data acquisition system 120 is an example of a system implemented as computer programs on one or more computers in one or more locations, in which the systems, components, and techniques described below can be implemented.

The collaborative data acquisition system 120 operates in two modes: training mode and inference mode.

During training mode, the system 120 receives a request 100 to generate additional data for a machine learning (ML) task.

After generating the additional data for the task, the system can operate in inference mode. During inference mode, the system 120 receives one or more inputs 110 for the ML task and processes each of the inputs 110 to generate a corresponding output 118 for the ML task. While operating in inference mode, the system 120 leverages the generated additional data from the training mode to improve the quality of the outputs 118.

These ML tasks can be any of a variety of tasks that can be performed by a neural network or other machine learning model. As a particular example, these tasks can be those that experience performance enhancement by drawing from diverse data sources.

For example, the ML task of next-token prediction, suggesting the most likely next text token for a given sequence of text tokens, benefits greatly from diverse data sources. Some example applications of next-token prediction include autocompleting user search field inputs, and autocompleting user messages to name a few. The models that perform these applications of next-word prediction take sequences of words or phrases as inputs and generate likelihoods of being the next token in the sequence from a list of text tokens, e.g., words, phrases, characters, or sub-words, as outputs. By drawing from a diverse source of data, such as various writing styles and topics presented by various users, next-word prediction models can better anticipate user writing.

As another example, the ML task of emoji prediction, predicting the most appropriate emoji to represent a message, also benefits from diverse data sources for similar reasons as the next-token prediction task does. Models for emoji prediction have inputs that include messages or phrases, and output likelihoods of emoji response for a list of emojis. By analyzing diverse data sources emoji prediction can be refined and used to enhance expressive capabilities.

As another example, the ML task of grammar error correction for written text benefits from diverse data (usually in the form of diverse writing styles for various contexts and purposes). Model inputs for the task generally include sentences or paragraphs, e.g., in natural language or computer code, while outputs consist of indications of errors with corresponding text representing corrections or style improvements. Writing or coding assistance tools and word processors that use models performing grammar error indication provide better results when the used model is trained on diverse user data such as writing associated with various contexts (school, personal, work, etc.) to various audiences (friend, teacher, peer, public, etc.).

As another example, the ML task can be spam detection (detecting whether a message is spam or not spam). During training mode, the system 120 responds to a request 100 to generate additional data for spam detection. Then, during inference mode, the system 120 receives one or more new messages, inputs 110. Using the generated additional data for spam detection, the system 120 processes one or more new messages to produce ‘spam’ or ‘not spam’ labels, outputs 118.

Generally, the system 120 includes one or more teacher computer systems 102 for generating additional data, and a student computer system 106 for processing inputs 110.

The one or more teacher computer systems 102 generate additional data by using private data to generate natural language teacher artifacts 104 to send to the student computer system 106.

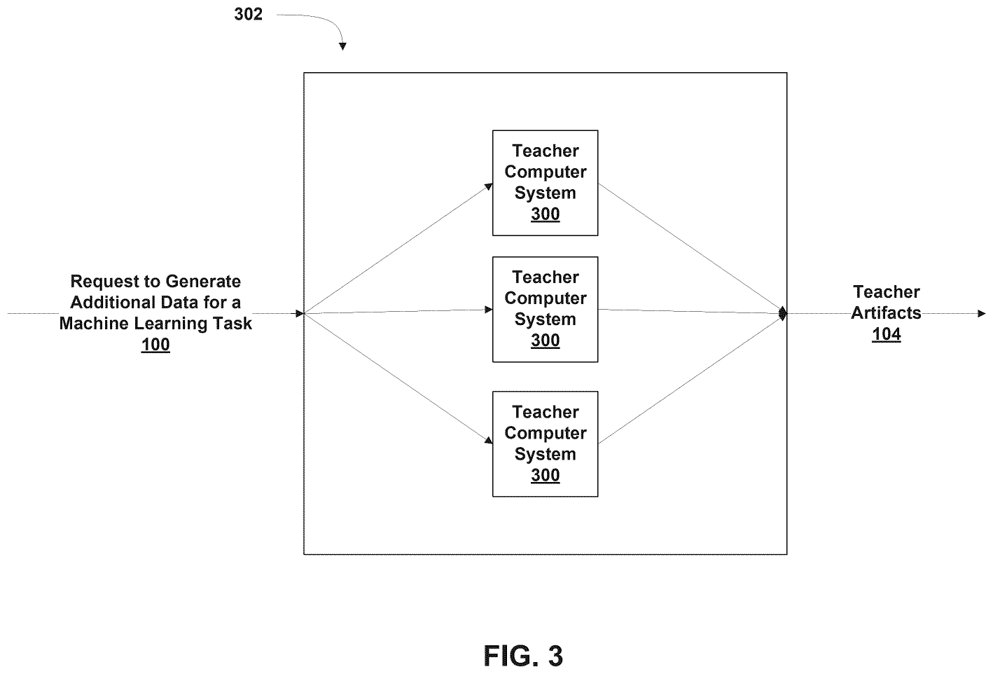

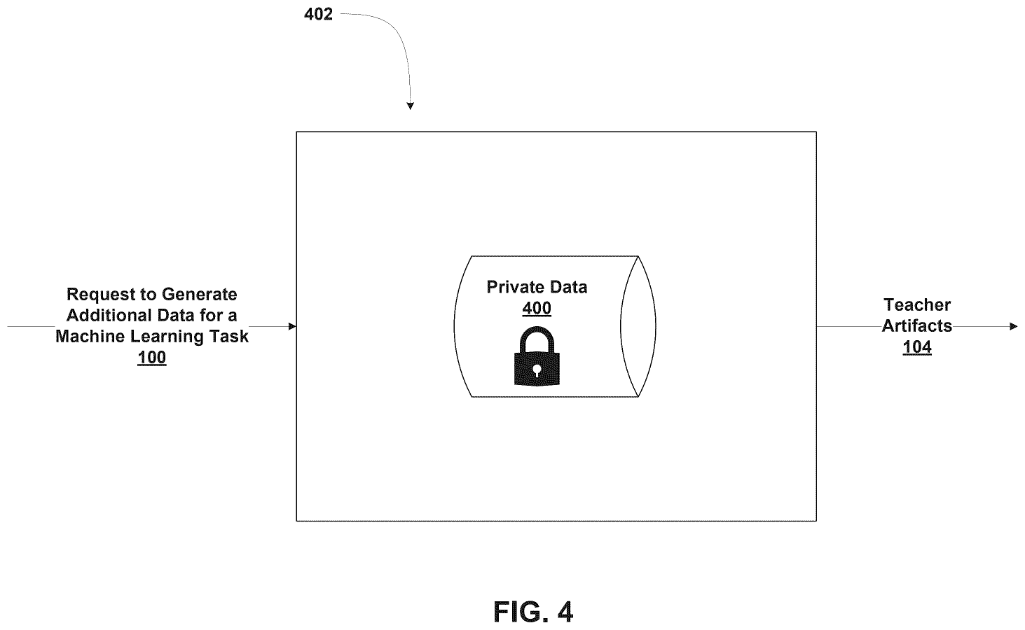

The one or more teacher computer systems 102 are described in more detail below with reference to FIG. 3 and FIG. 4.

The data associated with each of the one or more teacher computer systems 102 generally contains private data. Private data can include data that users do not wish to share publicly, such as health data, financial data, behavior data, communications data, and so on. For example, email correspondences are private communication data in the context of the earlier spam detection task.

As a particular example, each teacher computer system 102 can be deployed on or otherwise associated with a respective user device. Thus, the teacher computer system 102 may have access to private data that is stored on the corresponding user device and that cannot directly be shared with the student computer system 106 in order to maintain privacy and data security.

The natural language teacher artifacts 104 include only non-private data, data that does not expose the private information available to the one or more teacher computer systems 102. For example, machine-generated email correspondences, designed to simulate content and writing styles, but not written by any given individual and not including content from any existing correspondence, are examples of non-private communication data in the context of the earlier spam detection task.

Generating additional data instead of using private data not only protects user privacy, but also improves the quality of outputs 118. For example, for a general ML classification task, generating more data of a less frequently occurring class can help free predictions from bias towards a more frequently occurring class. In the context of the earlier spam detection task, if the system 120 has limited data on spam messages, generating additional spam data is imperative to prevent the system 120 from inaccurately favoring labeling messages as not spam.

In some cases, there may be constraints on how much data can be transmitted from the one or more teacher computer systems 102 to the student computer system 106 due to network bandwidth constraints. More generally, sending excessive amounts of data may be prohibitively costly in terms of consuming network bandwidth. For these cases, sending generated data that is smaller in size than, but equally as informative as or more informative than, the private data overcomes the data transmission constraints, while also protecting user privacy and improving quality of outputs 118.

In the context of the earlier spam detection task, if the system 120 has substantial data on not spam messages, generating additional data that is smaller in quantity and representative of not spam messages can prevent exceeding the system 120 communication constraints, while simultaneously protecting user privacy and improving the quality of outputs 118.

The generated teacher artifacts 104 can be any of a variety of natural language examples or natural language instructions or both.

A natural language example includes a natural language description of an input for the task and a corresponding target output for the input. Thus, for teacher artifacts 104 that are natural language examples, the teacher artifacts 104 include (i) a natural language input for the ML task and (ii) a natural language response to the natural language input.

A natural language example includes a natural language description of how to perform a given task. Thus, for teacher artifacts 104 that are natural language instructions, the teacher artifacts 104 are natural language instructions for performing the ML task.

Continuing with the spam detection task above, an example of a teacher artifact example may be “Text: Congratulations! You won $10M dollars \n Class: spam”, and an example of a teacher artifact instruction may be “If the message contains requests for personal information or keywords such as ‘free’, ‘winner’, ‘congratulations’label it is spam, otherwise label it is not spam.”

During the training mode, the student computer system 106 can use the teacher artifacts 104 with a prompt generator 108 to create natural language prompts 112 for the student neural network 116 to process inputs 110 to generate outputs 118. A prompt is a template input that can be processed as input by the student network 116 along with an input 110 that provides the student network 116 with information about the task.

That is, the prompt generator 108 initially creates a template using the teacher artifacts 104. Then, during the inference mode and for each received input 110, it completes the template by combining the template with the received input 110 and forwards the finalized natural language prompts 112 to the student neural network 116 to be processed.

The student neural network 116 can have any of a variety of neural network architectures that generate responses to the natural language prompt 112.

For example, the student neural network 116 can be a large language model (LLM) neural network that auto-regressively generates output sequences by processing a context sequence. The output sequences can be, e.g., sequences of text tokens, e.g., words, word pieces, bytes, characters, numbers, punctuation, or other text symbols. The output sequences can optionally also include tokens representing other types of data, e.g., image data, video data, audio data, and so on.

As another example, the student neural network 116 can be a text-conditioned image, audio, or video generation neural network. Examples of these include diffusion models.

The prompt generator 108 can be any of a variety of systems or methods that use teacher artifacts 104 to generate a natural language prompt 112 for a student neural network 116 to process inputs 110.

The prompt generator 108 can select a subset of received teacher artifacts 104 for use in generating the template through any of a variety of mechanisms. Examples of selection mechanisms include, selecting all received teacher artifacts 104, randomly selecting a subset of teacher artifacts 104, or selecting only the highest quality teacher artifacts 104.

The prompt generator 108 can use any of a variety of prompt engineering techniques to generate the template from the selected subset of artifacts 104. Examples of prompt engineering techniques include in-context learning prompting (through teacher artifact natural language examples), instruction learning prompting (through teacher artifact natural language instructions), or both.

For example, the prompt generator 108 can select and concatenate all teacher artifact examples, which serves as a prompt template. Then, the template is prepended to every received input 110, serving as finalized in-context learning natural language prompts 112.

For the spam detection task above, featuring the single teacher artifact example of “Text: Congratulations! You won $10M \n Class: spam” and a single input 110, “<text>”, the finalized in-context learning natural language prompt 112 is “Text: Congratulations! You won $10M \n Class: spam \n Message: <text> Class: ”. The output 118 would be the completion of this natural language prompt 112.

As another example, the prompt generator 108 can merge multiple teacher artifact instructions into one natural language instruction, which serves as a prompt template. Then, the template is prepended to every received input 110, serving as finalized instruction learning natural language prompts 112.

For the spam detection task above, featuring the single teacher artifact instruction of “If the message contains requests for personal information or keywords such as ‘free’, ‘winner’, ‘congratulations’ label it is spam, otherwise label it is not spam.” and a single input 110, “<text>”, the finalized instruction learning natural language prompt 112 is “If the message contains requests for personal information or keywords such as ‘free’, ‘winner’, ‘congratulations’ label it is spam, otherwise label it is not spam. Message: <text> Class: ”. The output 118 would be the completion of this natural language prompt 112.

In some implementations, instead of or in addition to using the prompt generator 108 to generate the prompt from the teacher artifacts 104, a training engine 114 can update the student neural network 116 using the teacher artifacts 104 before processing any inputs 110 of the ML task. For example, the training engine 114 can perform a fine-tuning process for the student neural network 116 that utilizes teacher artifact examples as a task-specific dataset.

In implementations that the prompt generator 108 does not use teacher artifacts 104, the prompt generator 108 still generates natural language prompts 112 for the student neural network 116. For example, the prompt generator 108 can create a natural language prompt using just the inputs 110. For the spam detection task above with a single input 110 “<text>”, the natural language prompt can be “Classify the following text as spam or not spam, <text>.”

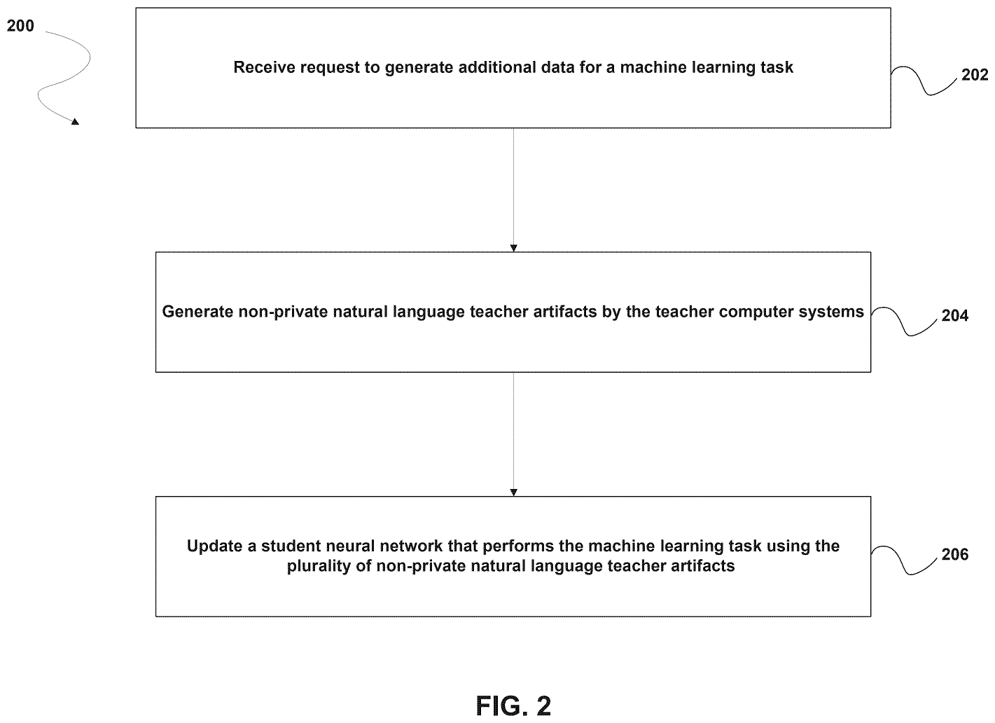

FIG. 2 is a flow diagram of an example process 200 for generating additional data for a machine learning task and using the data to update a student neural network. For convenience, the process 200 will be described as being performed by a system of one or more computers located in one or more locations. For example, a collaborative data acquisition system, e.g., the collaborative data acquisition system 120 depicted in FIG. 1, appropriately programmed in accordance with this specification, can perform the process 200.

The system receives a request to generate additional data, for a machine learning task (step 202). For example, the request can be initiated by a user of the student computer system described above, can be automatically generated by the student computer system in response to a request from the user to perform the task, or can be generated by the student computer system in response to determining that the performance of the student computer system on the task is below a threshold performance.

The request can be, for example, to generate one or more non-private natural language teacher artifacts, by teacher computer systems, for a machine learning task using data in private datasets available to the teacher computer systems.

The system generates non-private natural language teacher artifacts by the teacher computer systems (step 204).

For each teacher computer system, a respective private dataset with unique information contributes to generating the teacher artifacts. For example, as described above, each teacher computer system can be deployed on or otherwise associated with a respective user device. Thus, the teacher computer system can have access to data stored on the user device or in association with the user device, e.g., in cloud storage that is private to a user of the user device, that is private because it cannot directly be shared with other systems in order to main the privacy and security of the data.

When processing the request to generate teacher artifacts, each teacher computer system identifies relevant contents of its private dataset for the machine learning task. As a result, each teacher computer is poised to leverage its relevant unique private data to generate teacher artifacts for the machine learning task.

To generate the one or more teacher artifacts, each teacher computer system processes an input that includes (i) relevant data from its respective private dataset and (ii) a prompt using a corresponding teacher neural network to generate a natural language instruction for performing the machine learning task.

For example, each teacher computer system can process an input that includes one or more examples from its private dataset using a teacher neural network to generate an output that includes one or more non-private additional examples. In some cases, the teacher computer system can process multiple different inputs that each include a different set of one or more examples in order to generate multiple different natural language artifacts that each include a non-private additional example of performing the task.

As another example, each teacher computer system can first generate one or more non-private additional examples as previously described, and then, use the teacher neural network to process an input prompt that includes the non-private additional example(s) to generate a natural language instruction for performing the machine learning task. That is, the system can process the non-private additional examples to generate an output natural language instruction in accordance with the newly generated non-private data.

The teacher computer systems can generate teacher artifacts in parallel, or sequentially.

As an example of parallel generation, each teacher computer system can independently generate teacher artifacts.

As an example of sequential generation, a first teacher computer system can generate teacher artifacts. Then, a second teacher computer system can generate teacher artifacts with additional instructions to produce teacher artifacts distinct from previously generated teacher artifacts. Then, until all of the teacher computer systems have generated teacher artifacts, a next teacher computer system can continue generating teacher artifacts in the same fashion.

Example techniques for generating artifacts using the teacher computer systems are described in more detail below with reference to FIG. 3 and FIG. 4.

The collaborative data acquisition system updates a student neural network that performs the machine learning task using the plurality of non-private natural language teacher artifacts (step 206).

For example, as described above with reference to FIG. 1, updating the student neural network can include generating a natural language prompt by a prompt generator.

Another example of updating the student neural network can be training the student neural network on the non-private natural language teacher artifacts using a training engine.

Some examples of training the student neural network using the training engine follow.

As one example, the training engine can update the parameters of the student neural network using the task-specific dataset or combinations of the task-specific dataset and any other previously available dataset.

As another example, the training engine can use a prompt tuning technique to learn a “soft prompt” for the task that is provided to the student neural network along with any prompt generated by the prompt generator when processing any given input for the task.

As another example, the training engine can train a new replacement student neural network using the task-specific dataset or combinations of the task-specific dataset and any other previously available dataset.

As another example, the training engine can train one or more new student neural networks (to be used as an ensemble with or without the current student neural network) using the task-specific dataset or combinations of the task-specific dataset and any other previously available dataset.

Generally, this training can be performed using any appropriate objective function for the task. For example, when the student neural network is an LLM or other auto-regressive model, the objective function can be a next token prediction objective, e.g., a negative log-likelihood objective.

FIG. 3 shows an example 302 of the one or more teacher computer systems 102.

As described above with reference to FIG. 2, in response to receiving a request 100, each individual teacher computer system 300 uses its relevant private data to generate teacher artifacts 104.

Generally, to finalize the set of teacher artifacts 104 generated by the teacher computer systems 300, the student computer system 106 can function as an aggregator to aggregate the teacher artifacts 104 using any of a variety of aggregation mechanisms.

For example, to aggregate teacher artifact examples, the student computer system 106 can coordinate each teacher computer system 300 to “vote” on their preferred generated teacher artifacts examples. The student computer system 106 can then select the most preferred teacher artifacts as the final set of teacher artifact examples.

That is, before beginning the generation process, each teacher computer system 300 creates an evaluation dataset by holding out a subset of its private data, not used for generating the artifacts.

Then, after generation of all teacher artifact examples, each teacher computer system 300 receives all teacher artifact examples.

Next, each teacher computer system 300 separately computes a likelihood score for each teacher artifact example using its held-out evaluation dataset and votes for the candidate that has the highest likelihood.

For example, the teacher computer system 300 can assign, as the likelihood score for a given teacher artifact example, a likelihood, e.g., a log likelihood assigned to the teacher artifact example by the teacher neural network given an input sequence that includes the held-out evaluation dataset. As another example, the teacher computer system 300 can generate a likelihood score for a given teacher artifact example from respective likelihoods assigned by the teacher neural network to, for each example in the held-out evaluation data set, the output in the example given an input sequence that includes the input in the example and the given teacher artifact.

The student computer system 106 can then select the teacher artifact examples with the most votes.

In some other implementations, the student computer system 106 randomly selects a subset of teacher artifacts 104 to aggregate.

In some other implementations, the student computer system 106 aggregates all teacher artifacts 104 after generation.

FIG. 4. shows an example 402 of the teacher computer system 300.

As shown in FIG. 4, the teacher computer system 300 can use any of a variety of techniques to process a request 100 to generate teacher artifacts 104 using its private data 400.

For example, the teacher can use a neural network that has any variety of neural network architectures that generate responses to the natural language prompts requesting the generation of teacher artifacts 104. For example, the neural network belonging to a teacher computer system 402 can process natural language requests to generate teacher artifact examples using its private data. An example request could be,
The following examples are privately shared with you and will not be given to the participants.

### Private Data 400 Examples

### List Ten More Examples:

As another example, the neural network belonging to a teacher computer system 402 can also process natural language requests to generate teacher artifact instructions. An example request could be,
The following examples are privately shared with you and will not be given to the participants. Describe the format (any special markings used), and general patterns and any other useful generic notes that you can find based on these examples. What you write will be the only hint given to the participant and they are expected to output correct replies in the right format.

### Private Data 400 Examples

Task Format with Detailed Instructions:

The teacher artifacts 104 then include both the teacher artifact examples and teacher artifact instructions generated as a result of a teacher computer system 402 processing a request 100.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request to generate additional data for a machine learning task from data in one or more private datasets;
obtaining, in response to the request and from a set of one or more teacher computer systems, a plurality of non-private natural language teacher artifacts for the machine learning task generated from the one or more private datasets; and
updating, using the plurality of non-private natural language teacher artifacts, a student neural network that performs the machine learning task.

2. The method of claim 1, wherein one or more of the plurality of non-private natural language teacher artifacts comprise a natural language example that includes (i) a natural language input for the machine learning task and (ii) a natural language response to the natural language input.

3. The method of claim 1, wherein one or more of the plurality of non-private natural language teacher artifacts comprise a natural language instruction for performing the machine learning task.

4. The method of claim 1, wherein updating, using the plurality of non-private natural language teacher artifacts, a student neural network that performs the machine learning task comprises:
generating, from the plurality of non-private natural language teacher artifacts, a natural language prompt for the machine learning task.

5. The method of claim 4, wherein generating the natural language prompt comprises:
identifying one or more of the non-private natural language teacher artifacts; and
generating a concatenated sequence that includes the identified non-private natural language teacher artifacts.

6. The method of claim 5, wherein identifying one or more of the non-private natural language teacher artifacts comprises:
filtering the non-private natural language teacher artifacts to remove one or more of the non-private natural language teacher artifacts.

7. The method of claim 5, wherein identifying one or more of the non-private natural language teacher artifacts comprises:
for one or more of the non-private natural language teacher artifacts:
providing the non-private natural language teacher artifact to one or more of the teacher computer systems;
obtaining, from each of the one or more teacher computer systems, a respective measure of a quality of the non-private natural language teacher artifact; and
determining whether to include the non-private natural language teacher artifact in the prompt based on the respective measures.

8. The method of claim 4, further comprising:
receiving a new input for the machine learning task; and
processing an input that comprises the natural language prompt and the new input using the student neural network to generate a new output for the machine learning task.

9. The method of claim 1, wherein updating, using the plurality of non-private natural language teacher artifacts, a student neural network that performs the machine learning task comprises:
training the student neural network on the non-private natural language teacher artifacts.

10. The method of claim 9, further comprising:
after training the student neural network on the non-private natural language teacher artifacts:
receiving a new input for the machine learning task; and
processing an input that comprises the natural language prompt and the new input using the student neural network to generate a new output for the machine learning task.

11. The method of claim 1, wherein the set of one or more teacher computer systems comprises a plurality of teacher computer systems.

12. A method performed by one or more computers, the method comprising:
receiving, by a teacher computer system, a request to generate additional data for a machine learning task from data in a private dataset available to the teacher computer system;
generating, by the teacher computer system, one or more teacher artifacts for the machine learning task from the data in the private dataset; and
providing the one or more teacher artifacts to a student computer system for use in updating a student neural network that performs the machine learning task.

13. The method of claim 12, wherein generating, by the teacher computer system, one or more teacher artifacts for the machine learning task from the data in the private dataset comprises:
processing an input that comprises (i) the data in the private dataset and (ii) a prompt to generate a natural language instruction for performing the machine learning task using a teacher neural network to generate an output that comprises the natural language instruction; and
including, as one of the one or more teacher artifacts, the natural language instruction.

14. The method of claim 12, wherein generating, by the teacher computer system, one or more teacher artifacts for the machine learning task from the data in the private dataset comprises:
processing an input that comprises one or more examples from the data in the private dataset using a teacher neural network to generate an output that comprises an additional example; and
including, as one of the one or more teacher artifacts, the additional example.

15. The method of claim 12, wherein generating, by the teacher computer system, one or more teacher artifacts for the machine learning task from the data in the private dataset comprises:
processing an input that comprises (i) one or more examples from the data in the private dataset and (ii) an instruction to generate a non-private version of the one or more examples using a teacher neural network to generate an output that comprises an additional example; and
including, as one of the one or more teacher artifacts, the additional example.
